(19) United States
(12) Patent Application Publication
(10) Pub. No.: US 2020/0064288 A1
(43) Pub. Date: Feb. 27, 2020

(54) GAS SORPTION SCREENING

(71) Applicant: The University of Liverpool, Liverpool (GB)

(72) Inventors: Andrew COOPER, Liverpool (GB); Robert CLOWES, Liverpool (GB)

(21) Appl. No.: 16/487,634

(22) PCT Filed: Feb. 21, 2018
(86) PCT No.: PCT/GB2018/050450

§ 371 Date: Aug. 21, 2019

(30) Foreign Application Priority Data
Feb. 21, 2017 (GB) 1702785.5

(51) Int. Cl. G01N 25/48; G01N 15/08; G01J 5/00; B01J 20/34

(52) U.S. Cl. CPC G01N 25/4873; G01N 15/088; G01N 1/34; B01J 20/3458; G01N 2015/0833; G01J 5/0014

(57) ABSTRACT

This invention relates to a gas sorption screening device and a method for gas sorption screening. It allows assessment of whether a substance is porous to a particular gas or vapour; the generation of simple low-resolution isotherm profiles; and provides indications on gas selectivity.

This invention relates to a gas sorption screening device and a method for gas sorption screening.

### BACKGROUND

Porous materials is a growing research field, with active areas including zeolites, activated carbons, Porous Organic Cages (POCs), Conjugated Microporous Polymers (CMPs), Covalent Organic Frameworks (COFs), Metal-Organic Frameworks (MOFs) and Porous Coordination polymers (PCPs). These materials are interesting due to their potential applications in areas such as gas storage, gas separations, heterogeneous catalysis, and others.

Often the bottleneck in porous materials discovery is not the synthesis of the materials but their analysis. In this regard, the development of high-throughput technology to analyse the gas sorption properties of new materials is very important. Such high-throughput systems are common for analysis techniques such as Nuclear Magnetic Resonance (NMR), Powder X-ray Diffraction (PXRD) and IR spectroscopy but much less so for gas sorption. Conventional gas sorption analysis uses either gravimetric analysis or volumetric analysis. However, it can be problematic to run multiple samples simultaneously in instruments of these types. Furthermore, these systems can be very technologically complex, and not amenable to studying multiple samples rapidly. Additionally, the known methods can be expensive. New methods, for example those using robotics, have been developed for making libraries of candidate materials that can result in much larger libraries. For example, these new technologies may create a batch of 96 candidate porous solids in one batch. The currently available analytical methods cannot process such a candidate library quickly or efficiently, resulting in delays in identifying suitable materials.

### BRIEF SUMMARY OF THE DISCLOSURE

Aspects provide a device and method as set forth in the appended claims.

### BRIEF DESCRIPTION OF THE DRAWINGS

Embodiments of the invention are further described hereinafter with reference to the accompanying drawings, in which:

FIG. 1 is a block diagram illustrating a gas sorption screening device;

FIG. 2 is a top view of an example sample plate for use in the gas sorption screening device of FIG. 1;

FIG. 3 is a diagram of an embodiment of gas sorption screening device;

FIG. 4 is a flowchart indicating a gas screening method;

FIG. 5 is an example output of a thermal imaging camera of the gas sorption screening device showing the sample plate in air at room temperature in the vacuum chamber;

FIG. 6 is an example output of the thermal imaging camera of the gas sorption screening device showing the sample plate as the vacuum chamber is slowly evacuated;

FIG. 7 is an example output of the thermal imaging camera of the gas sorption screening device showing the sample plate as the temperature is increased;

FIG. 8 is an example output of the thermal imaging camera of the gas sorption screening device showing the sample plate in a fully evacuated vacuum chamber at 60° C.;

FIG. 9 is an example output of the thermal imaging camera of the gas sorption screening device at degas conditions of 80° C. and 1.2 Pa (1.2×10⁻² mbar) for 10 hours;

FIG. 10 is an example output of the thermal imaging camera of the gas sorption screening device at 20° C. after degassing;

FIG. 11 is an example output of the thermal imaging camera of the gas sorption screening device when a first quantity of CO₂ is admitted into the vacuum chamber;

FIG. 12 is an example output of the thermal imaging camera of the gas sorption screening device after the vacuum chamber has been equilibrated after the first quantity of gas;

FIG. 13 is an example output of the thermal imaging camera of the gas sorption screening device when a second quantity of CO₂ is admitted into the vacuum chamber;

FIG. 14 is an example output of the thermal imaging camera of the gas sorption screening device after the vacuum chamber has been equilibrated after the second quantity of gas;

FIG. 15 is an example output of the thermal imaging camera of the gas sorption screening device when a third quantity of CO₂ is admitted into the vacuum chamber;

FIG. 16 is an example output of the thermal imaging camera of the gas sorption screening device after the vacuum chamber has been equilibrated after the third quantity of gas;

FIG. 17 is an example output of the thermal imaging camera of the gas sorption screening device when a fourth quantity of CO₂ is admitted into the vacuum chamber;

FIG. 18 is an example output of the thermal imaging camera of the gas sorption screening device after the vacuum chamber has been equilibrated after the fourth quantity of gas;

FIG. 19 is an example output of the thermal imaging camera of the gas sorption screening device equilibrated to the pressure of the gas vessel;

FIG. 20 is an example output of the thermal imaging camera of the gas sorption screening device equilibrated to 0.9 bar;

FIG. 21 is an example output of the thermal imaging camera of the gas sorption screening device with a slow evacuation;

FIG. 22 is an example output of the thermal imaging camera of the gas sorption screening device with a fast evacuation;

FIG. 23 is an example output of the thermal imaging camera of the gas sorption screening device at vacuum;

### DETAILED DESCRIPTION

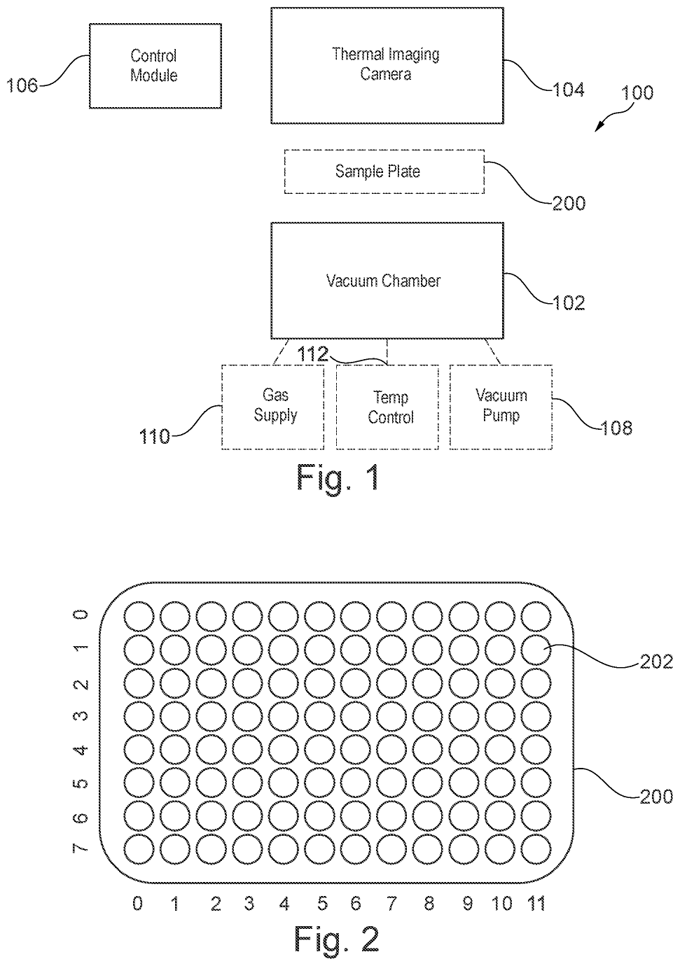

Referring initially to FIGS. 1 and 2, there is shown a block diagram of a gas sorption screening device, indicated generally by the reference numeral 100, comprising a vacuum chamber 102, a thermal imaging camera 104 and a control module 106. A sample plate 200 can be placed in the vacuum chamber 102. The vacuum chamber comprises a chamber having a lid that may be secured to provide a suitable seal to enable a vacuum to be established in the chamber. The lid has an IR-transparent window (not shown) therein. The vacuum chamber has a gas outlet (not shown) which may be connected to a vacuum pump 108 suitable for establishing a vacuum in the vacuum chamber. The vacuum chamber 102 further comprises a gas inlet (not shown) through which a test gas may be admitted into the vacuum chamber 102. The gas inlet (not shown) is located in the base of the vacuum chamber 102, but may be located elsewhere.

The gas inlet may be connected to a gas supply system for one or more test gases. The gas supply system may comprise a test gas delivery module (not shown) and a gas canister (not shown). The vacuum chamber 102 may be connected to a temperature control unit 112 for controlling the temperature of the chamber as required. The vacuum chamber, including lid and IR-transparent window are non-porous to the test gas(es).

The gas sorption screening device 100 further comprises a control module 106. The control module 106 may be implemented on a PC, a dedicated device or other suitable processing device. The control module 106 manages and stores the data from the thermal imaging camera 104. The control module 106 may also control the temperature control unit 112, vacuum pump 108 and gas supply system 110.

Referring now to FIG. 2, there is shown a top view of an example sample plate 200 for use in the gas sorption screening device 100. The sample plate 200 comprises ninety-six circular sample areas each comprising a circular well 202, the sample areas being arranged in eight rows of twelve. Individual wells can be identified according to column and row notation, for example the wells of the first column would be identified as wells (0, 0) to (0, 7). The wells may have volume of the order of 1 μl to 10 μl. The wells may have a depth in the range 2 mm to 4 mm, preferably 3 mm. Preferably, the sample plate may be made from polypropylene, as it has a low thermal conductivity. Preferably, the sample plate is black in colour, as this can reduce back-reflection for the thermal imagine camera. Preferably, the sample plate is opaque, as this can reduce back-reflection for the thermal imagine camera. Typically, the sample plate may be a microtiter plate such as a Kibron DynePlate or a Perkin Elmer ProxiPlate. Microtiter plates are very convenient for use in the gas sorption screening device 100, however it will be understood that their use is not a requirement. Any sample plate, sample tray or other sample holder that allows sample quantities of materials to be tested to be placed thereon or therein such that the samples may be imaged from above by the thermal imaging camera may be used. Use of a microtiter tray or similar having a plurality of wells or recesses facilitates loading of the samples thereof while the sample tray is placed in the vacuum chamber.

In use, the wells 202 of the sample plate 200 are loaded with samples of materials to be screened for gas sorption. The samples are activated by applying suitable vacuum and temperature conditions via the vacuum pump 108 and temperature control unit 112. Once activated, a quantity of a test gas is admitted into the vacuum chamber 102 and the change in temperature of samples, due to the heat of adsorption as the sample materials adsorb the gas, is detected by the thermal imaging camera 104. The thermal imaging camera 104 may capture thermal images at one or more key timepoints in the process or may capture images regularly throughout the activation and/or delivery processes. Example key timepoints may be during the admission of the test gas, and subsequent to the passing of a defined equilibration period, such as 5 or 10 minutes. Analysis of the captured thermal images allows identification of those samples that experience a temperature change during the activation and/or delivery processes, thus allowing a measure of those materials' gas sorption properties to be established. According to examples, there is no, or negligible, chemical reaction between the samples and the test gas.

Using a sample plate 200 having a large number of wells 202, e.g. a standard microtiter plate having 96 or 384 wells, in the gas sorption screening device 100 provides for high throughput of samples. Additionally, the use of the microtiter plate allows for convenient sample preparation and loading. The device 100 is highly adaptable as no modifications are required to the analysis chamber to change to a sample plate having a different number of sample areas; and only minor modifications would be required to the control module.

The gas sorption screening device 100 conveniently allows activation and screening to take place in the same device, thus avoiding having to move activated samples from an activation device to a screening device. This is particularly beneficial for sensitive samples. The device 100 may also be used to determine the best activation conditions for materials, by monitoring results for a range of temperatures and vacuum levels.

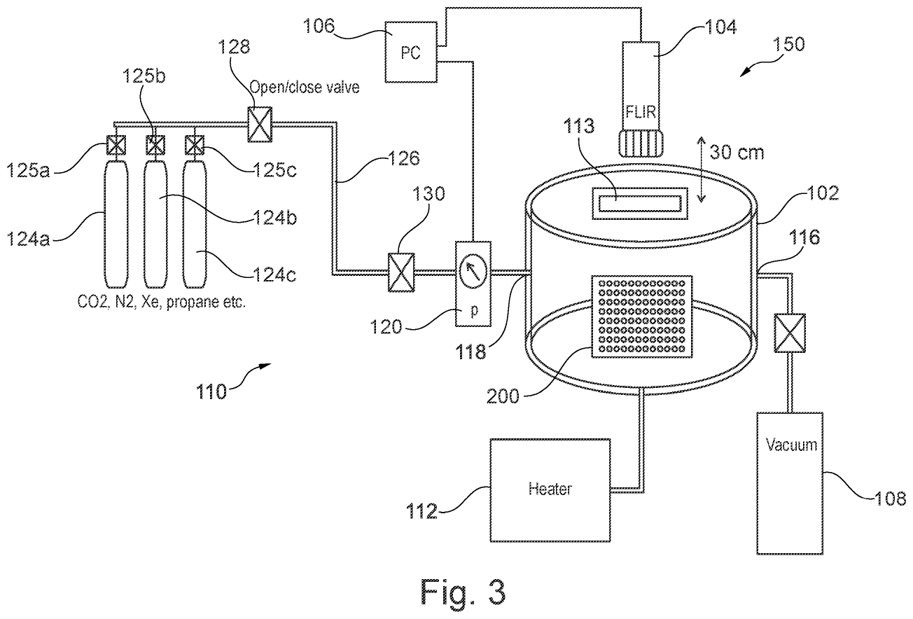

Referring now to FIG. 3, there is shown an example embodiment 150 of a gas sorption screening device. The gas sorption screening device 150 comprises a vacuum chamber 102. The vacuum chamber 102 may be cylindrical in shape, but other shapes may be used. In one example arrangement, the vacuum chamber 102 is formed of a stainless steel, jacketed, high vacuum chamber with an internal diameter of 213 mm and an internal height of 50 mm. In this way, the internal volume of the volume chamber is approximately 2 litres, allowing the desired vacuums to be established relatively quickly, and further allowing equilibration to happen relatively quickly. The vacuum chamber 102 may have a removable lid (not shown) with a 150×105×10 mm IR-transparent window 113 formed from Zinc Selenide (ZnSe) with a 3-12 um antireflective coating. The lid may be sealed via a DN200 ISO-K flange, centring ring, and clamps. The vacuum chamber 102 may have a recess (not shown) in its floor for receiving the sample plate 200. The recess may ensure that the sample plate 200 is correctly located in the vacuum chamber 102 for analysis by the thermal imaging camera 104.

In one example arrangement, the temperature control unit 112 comprises a refrigerating/heating circulation bath adapted to flow a thermo-fluid such as silicone oil through the jacket in the base and sides of the vacuum chamber. Such a system may provide for a temperature change rate of roughly 1° C. per minute. In this way, the internal temperature of the vacuum chamber 102 may be controlled as desired. Use of a circulation system that facilitates reasonably fast changes in the temperature of the vacuum chamber allows the device to change from the activation stage to the testing stage relatively quickly.

The thermal imaging camera 104 is mounted over the vacuum chamber 102 and focussed on the sample plate 200 through the IR-transparent window 113. In an example arrangement, thermal imaging camera 104 may be a FLIR Systems SC 645 Thermal Imaging Camera, having a resolution of 640×480 pixels, a temperature range of −20° C. to 150° C., temperature resolution of +/−50 mK and a frequency of 6 Hz. Typically, such a thermal imaging camera 104 may be positioned to be 30 cm above the sample plate and located above the vacuum chamber 102 such that it is focused through the ZnSe window 113. The window 113 may have an anti-reflective coating and the thermal imaging camera 104 may be mounted at an angle to the vertical, for example in the range 10°-20°, preferably 15°. In this way, the system may be arranged to reduce back-reflection onto the camera. The thermal imaging camera 104 will capture an infrared image of the sample plate 200. The captured image is a greyscale image, wherein the darkness of a pixel corresponds to the heat of the object, or portion of object, represented by that pixel such that the darker the pixel the colder the object. The gas sorption screening device provides for the value of each pixel to be translated into a temperature value. This may be carried out automatically by the thermal imaging camera or may be carried out by the control module.

The vacuum chamber 102 comprises a gas inlet 118 through which a quantity or quantities of test gas may be admitted into the vacuum chamber 102. The gas inlet 118 is connected to the gas supply system 110. The gas supply system 110 may comprise one or more gas canisters 124a, 124b, 124c each fitted with a regulator 125a, 125b, 125c. A test gas delivery module 122 is fitted between the gas canisters 124a, 124b, 124c and the gas inlet 118. The test gas delivery module 122 is adapted to be connected to at least of the one gas canisters 124a, 124b, 124c, and further adapted to be connected to the gas inlet 118. A delivery container 126 for the test gas is located between the connections with fluid flow therein controlled by a distal valve 128 and a proximal valve 130. In an example arrangement, the delivery container 126 may take the form of a 2 m coil of stainless steel tubing controlled by inline valves. The delivery container 126 has a fixed volume corresponding to the desired quantity of test gas to be admitted to the vacuum chamber 102. A typical test gas test quantity would be in the range 300 cm³ to 400 cm³, and may preferably be 350 cm³. It will be apparent to the person skilled in the art that other volumes may be used.

Test gases may include carbon dioxide, nitrogen, helium, argon, xenon, krypton, propane, propene, sulphur hexafluoride and so on, typically of at least 99.995% purity. The gas sorption screening device is suitable for use with any test gas, including flammable gases. By allowing for the use of a wide range of test gases, the gas sorption screening device can be employed for different uses. For example the device could be useful to screen materials for carbon capture if responses to carbon dioxide and nitrogen are studied, or to screen materials for gas separations if responses to propane/propene or krypton/xenon are studied.

The vacuum chamber 102 comprises a gas outlet 116 which may be connected to a vacuum pump 108 for generating a vacuum in the vacuum chamber 102. Typically, a single stage vacuum pump may be used, such as may be referred to as a backing pump or roughing pump. The vacuum pump is adapted to implement a pressure of the order of 1 Pa to 10 Pa in the vacuum chamber 102. The pressure in the vacuum chamber is measured using an absolute pressure transducer 120, for example a Swagelok transducer and suitable power supply.

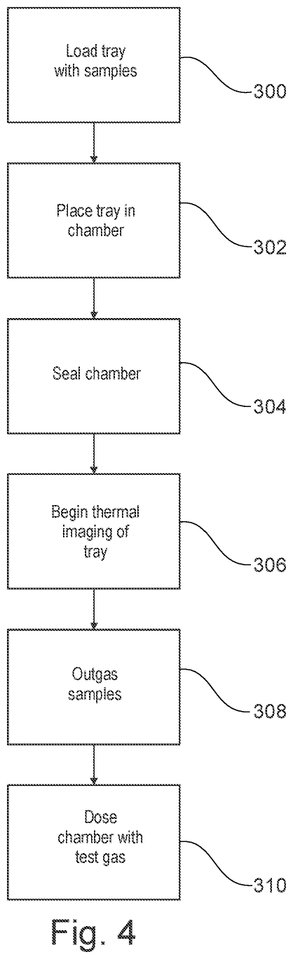

Referring now to FIG. 4, a method of gas sorption screening is described. In step 300, the sample plate 200 is loaded with the samples to be tested. One or more sample areas, selected at random in the sample plate 200, may be left empty to allow estimation of the temperature change of the plate itself. Typically, between five and ten sample areas may be left empty, arranged throughout the sample plate 200. Preferably, where the sample plate is a microtiter plate having wells, those wells containing a sample material are substantially filled with the sample material. In step 302, the sample plate 200 is placed in a pre-defined location in the vacuum chamber 102. Preferably, the pre-defined location may be defined as a recess in the floor of the vacuum chamber 102, however, it will be apparent to the person skilled in the art that other ways of ensuring the correct location of the sample plate 200 may be used.

In step 304, the vacuum chamber is sealed. In step 306, the thermal imaging camera 104 may begin thermal imaging of the plate through the IR-transparent window 113 in the lid of the vacuum chamber. The thermal imaging camera 104 may capture one IR image at regular intervals, for example every second, however it is not necessary to do so. In another aspect, the thermal imaging camera may capture images only a selected timepoints during the process. The pressure transducer may capture a pressure measurement at substantially the same time as each thermal image is captured.

In step 306, the outgassing of the samples takes place. In general, this may also be referred to as the activation of the samples. Activating of the samples in this way, in the chamber where the gas screening will take place, is convenient and efficient. It allows the user to avoid having to transfer activated samples from an activation environment to the gas sorption screening environment. The outgassing, or activation, may comprise a number of steps. Firstly, the vacuum pump will begin a slow evacuation of the vacuum chamber 102, followed by the temperature of the chamber being increased. Once the outgassing conditions of 80° C. at 1.2 Pa (1.2×10⁻² mbar) are achieved, they are maintained for 10 hours. Typically, this outgassing step may occur overnight. Other outgassing conditions may be used. For example, degassing may be carried out for 24 hours at 70° C. under dynamic vacuum.

Certain materials may need different activation conditions, for example, catalysts may need to be activated by heating to a high temperature under gas e.g. 300° C. under helium. The present device may operate such an activation, with straightforward adjustments to the temperature control system and by ensuring that the plate material or sample container is chosen to be compatible with such temperatures.

In step 310, a quantity of test gas, for example CO₂, is admitted into the vacuum chamber 102. The chamber may first be brought back to room temperature, at circa 20° C. The method is not limited to CO₂ but can be applied to most non-corrosive permanent gases, such as nitrogen, methane, ethane, ethane, propane, propene, sulfur hexafluoride, and inert gases (e.g., krypton, xenon).

The admission of the test quantity of test gas comprises opening the regulator on the gas canister, with the proximal valve 130 closed and the distal valve 128 open, to allow the delivery container 126 to fill with the chosen test gas to the pressure set by the regulator 125, typically 100 kPa (1 bar). The distal valve 128 is then closed and the proximal valve 130 opened such that the quantity of test gas is admitted to the vacuum chamber 102. After the proximal valve has been opened, the device is given time to come to temperature equilibration, for example in the region of 5 to 10 minutes. In this way, any temperature changes occurring as a result of the gas will have been captured by the thermal imaging camera and the temperature of the samples will be substantially uniform again. After the equilibration period has passed, the proximal valve is closed.

Step 310 may be repeated multiple times. For example, a sequence of 10 doses of test gas may be useful. Alternatively step 310, including the equilibration step, may be run repeatedly until a target pressure such as 50 kPa or 90 kPa is reached in the vacuum chamber 102. Additionally, it may be useful to run a first sequence for a first test gas, repeat the activation step and then run a second sequence for a second test gas. Having a gas supply system comprising a number of different gas canisters connected to the test gas delivery module 122 in useful in this regard.

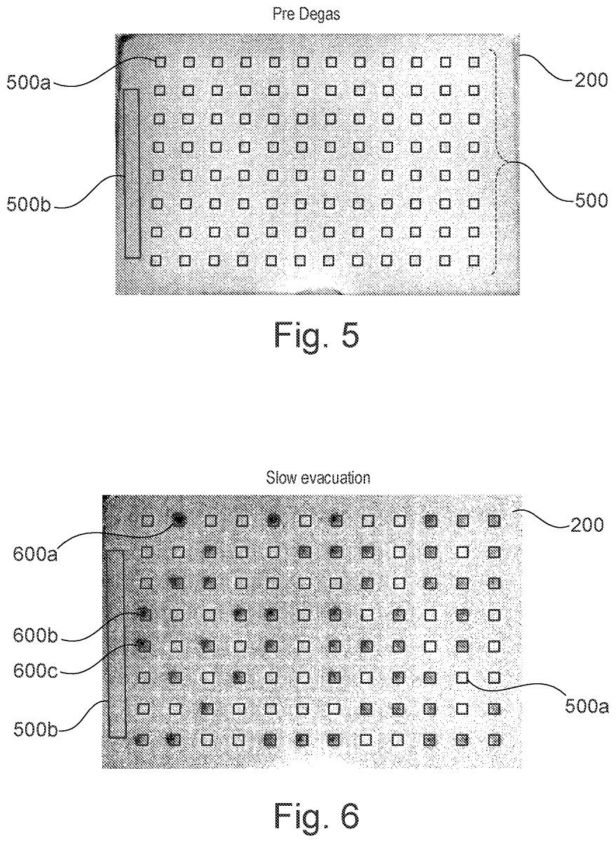

Referring now to FIGS. 5 to 23, these figures show output images of the thermal imaging camera 102 as provided by the control module 106. The output images comprise a mask 500 overlaid on the output. The mask comprises a number of defined shapes, in this case squares 500a, whose size and location substantially correspond to the locations of the sample areas in the image of the sample plate 200 captured by the thermal imaging camera 104. In this case, the sample areas are wells 202 in a microtiter plate. In FIG. 5, the mask 500 has been highlighted for clarity. It may be less visible in FIGS. 6 to 23, however it is present in each figure. The mask 500 further comprises a reference block 500b corresponding to a portion of the sample plate 200 containing no wells 202 or sample material.

In FIG. 5, the output of the thermal imaging camera 106 for room temperature non-activated samples is shown. It can be seen that the temperature of the sample plate 200 including its samples is substantially uniform.

In FIG. 6, a slow evacuation of the vacuum chamber 102 has begun. It can be seen that the image has darkened in the regions corresponding to certain samples e.g. 600a, 600b, 600c (samples areas (0,3) (0,4) and (0,7)) in the sample plate 200, indicating that their temperatures have dropped, while the image of other samples remains similar to that of the tray, indicating that their temperature remains substantially unchanged.

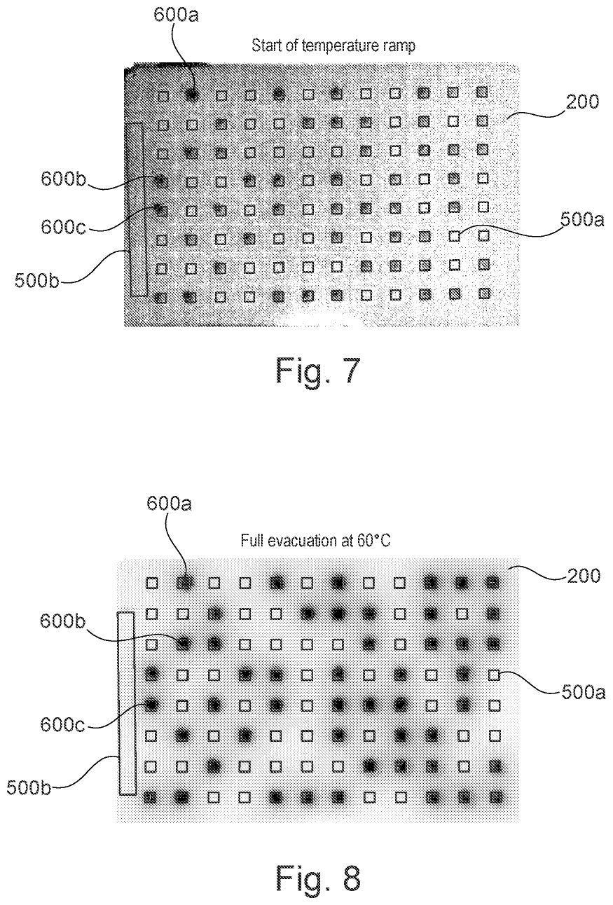

In FIG. 7, the temperature of the vacuum chamber 102 has started to increase. The already darkened/cooled samples remain darkened, while the remaining samples begin to show indications of lightening/heating.

In FIG. 8, the image shown is that of the sample tray when the vacuum chamber has been fully evacuated to a pressure below 100 Pa. and heated to a temperature of 60° C. It can be seen that the darkened/cooled samples are still cool while the sample plate 200 and remaining samples have lightened, corresponding to their heating to 60° C.

It can be seen from FIGS. 6 to 8, that a strong indication of the gas sorption properties of a sample can be obtained in the activation stage. A sample with good gas sorption properties will heat up as it adsorbs a gas. However, it will also cool down as it desorbs gases. This desorption is triggered by the application of the vacuum in the vacuum chamber. Therefore the activation stage, also referred to as the outgassing or degassing stage, will cause a drop in temperature in a sample with high gas sorption. This temperature drop is captured by the present gas screening device and may provide an early indication that this material has high gas sorption.

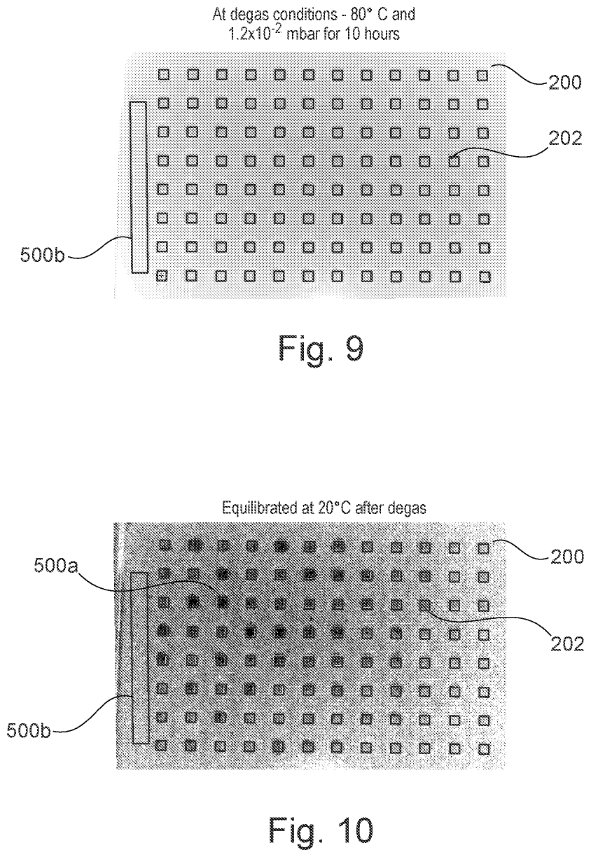

FIG. 9 shows the output of the thermal imaging camera after the vacuum chamber 102 has been maintained at activation conditions of 80° C. and 1.2 Pa (1.2×10⁻² mbar). In this image, it can be seen that the sample plate 200 and all samples are at substantially the same temperature.

FIG. 10 shows the output of the thermal imaging camera after the vacuum chamber containing the activated samples has been equilibrated at 20° C.

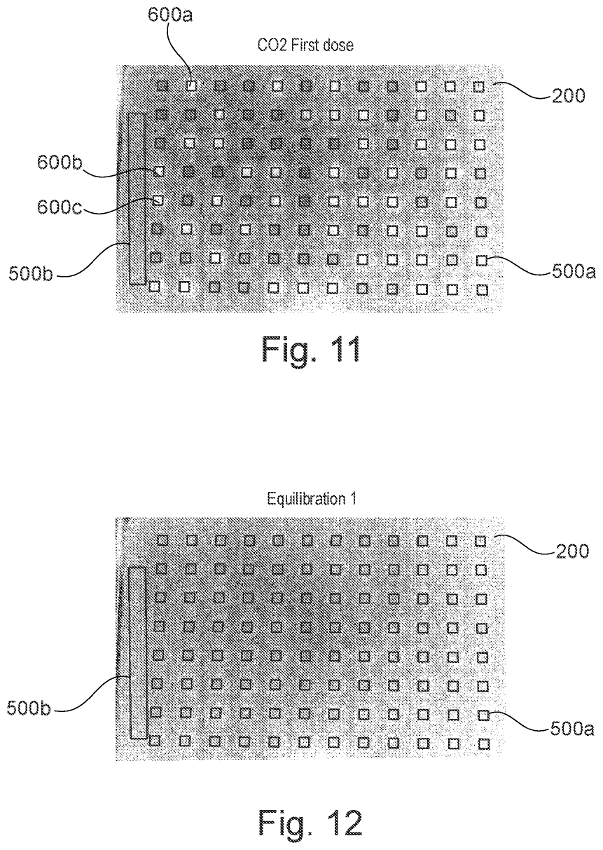

FIG. 11 shows the output of the thermal imaging camera as a first quantity, typically 350 cm³, of carbon dioxide is admitted into the vacuum chamber 102. It can be seen that the image of certain samples has lightened indicating an increase in temperature. It will be noted that the samples that have increased in temperature at the delivery of carbon dioxide are the same as those that decreased in temperature during degassing.

FIG. 12 shows the output of the thermal imaging camera after the vacuum chamber 102 has been equilibrated at 20° C.

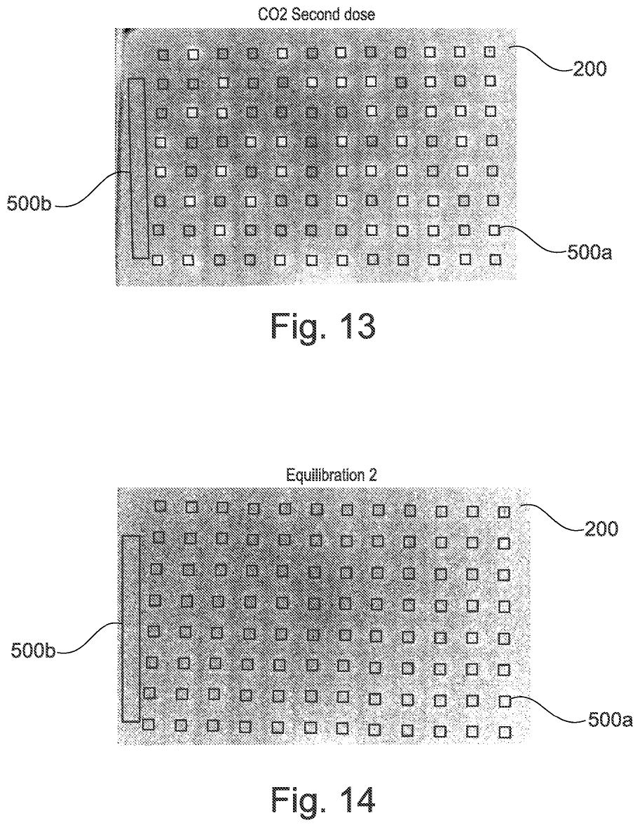

FIG. 13 shows the output of the thermal imaging camera as a second quantity of carbon dioxide is admitted into the vacuum chamber 102.

FIG. 14 shows the output of the thermal imaging camera after the vacuum chamber 102 has been equilibrated 20° C.

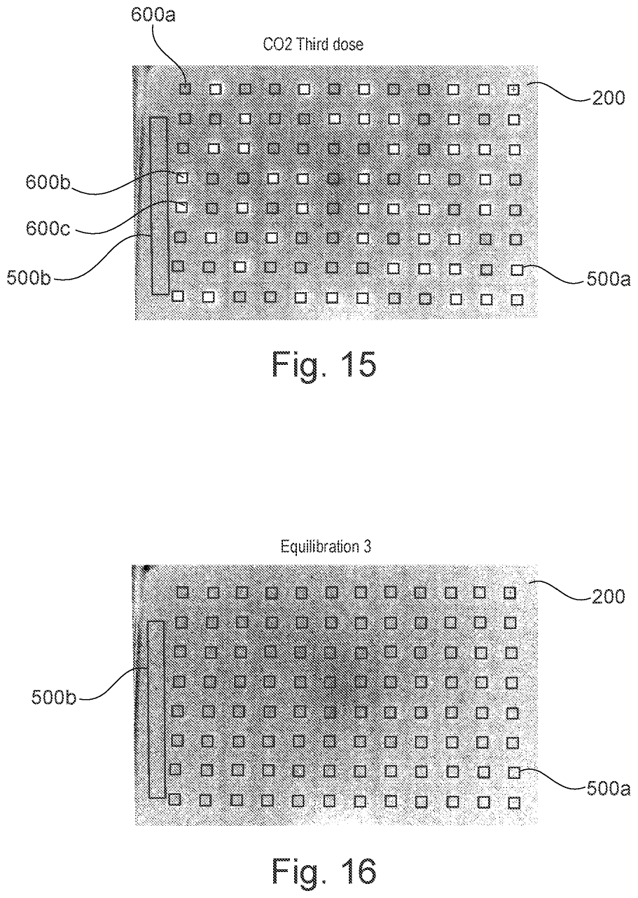

FIG. 15 shows the output of the thermal imaging camera as a third quantity of carbon dioxide is admitted into the vacuum chamber 102.

FIG. 16 shows the output of the thermal imaging camera after the vacuum chamber 102 has been equilibrated.

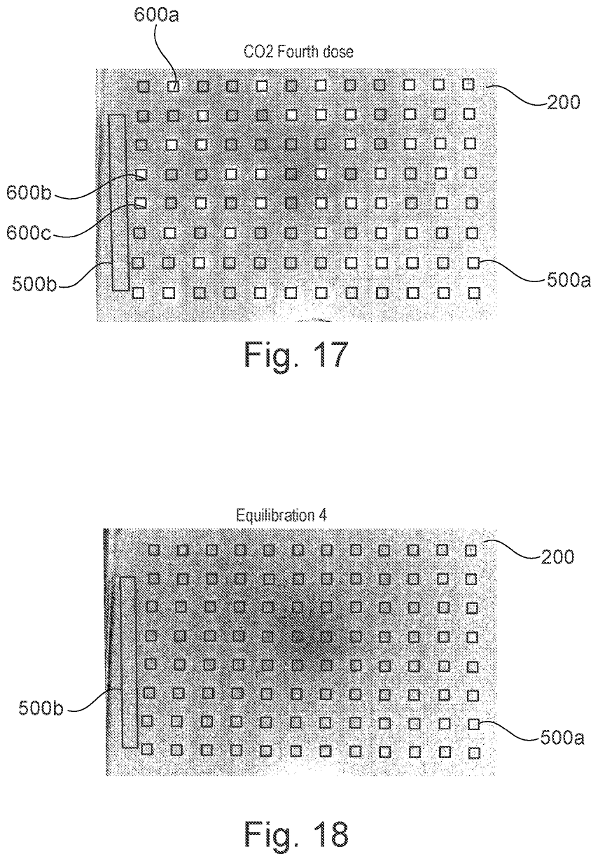

FIG. 17 shows the output of the thermal imaging camera as a fourth quantity of carbon dioxide is admitted into the vacuum chamber 102.

FIG. 18 shows the output of the thermal imaging camera after the vacuum chamber 102 has been equilibrated. It can be seen from FIGS. 10 to 18 that each time the carbon dioxide is admitted the same samples increase in temperature and that everything returns to the same temperature at equilibration.

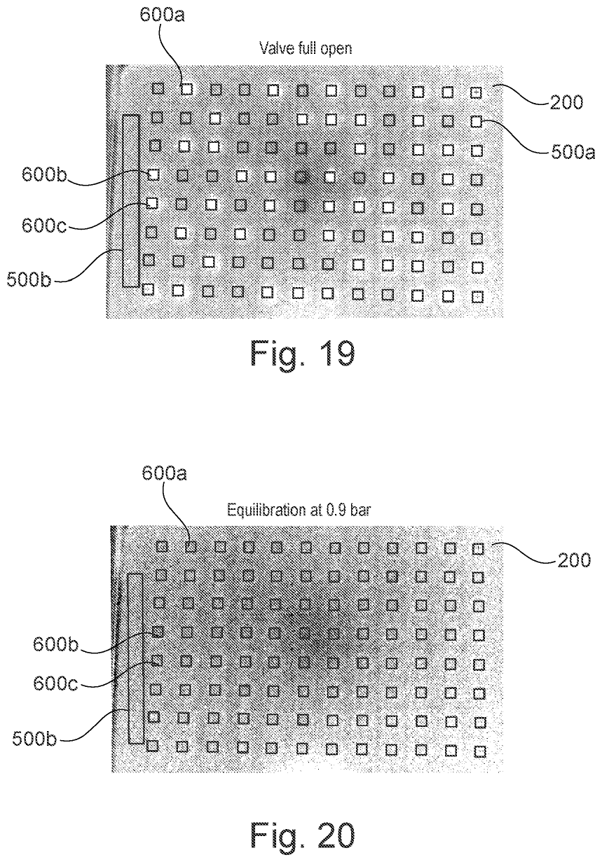

FIG. 19 shows the output from the thermal imaging camera when the vacuum chamber is open to the pressure of the gas canister, which may be 90 kPa (0.9 bar). This may be achieved by opening the canister valve, the distal valve and the proximal valve. This step is taken once the desired number of gas quantities have are admitted and the results recorded. Again, it can be seen in this image that certain wells have lightened in temperature, indicating an increase in temperature.

FIG. 20 shows the output from the thermal imaging camera after an equilibration period after opening the vacuum chamber at 90 kPa (0.9 bar). It can be seen that the samples and sample plate are substantially at the same temperature.

The gas sorption screening device records a pixel value for each pixel in the thermal imaging camera 102 and a pressure measurement from the pressure transducer, for every timepoint. The pixel information may be converted into temperature information, either by the thermal imaging camera itself or by the control module. In one example, a thermal image and a pressure measurement are captured every second. This provides for very granular data and allows accurate plots of the changes in temperature and pressure to be created. Alternatively, a thermal image and a pressure measurement are captured only at certain timepoints, for example, while the gas is being admitted to the chamber and after any equilibration periods. It will be understood that other timepoints may be chosen.

Once the temperature information is available for each pixel, it is possible to calculate the temperature for the corresponding samples. The average of the temperatures of the pixels within a mask square 500a corresponding to a particular sample area are calculated. The temperature of the reference area 500b may be subtracted from the calculated sample temperature to normalise the effects of the temperature change of the plate. If the sample plate 200 contains empty sample areas, their temperature change may also be analysed. The temperature of the empty wells may be averaged with the temperature of the reference block 500b and then subtracted from the temperature of the samples. This eliminates the effects of the temperature changes of the plate 200.

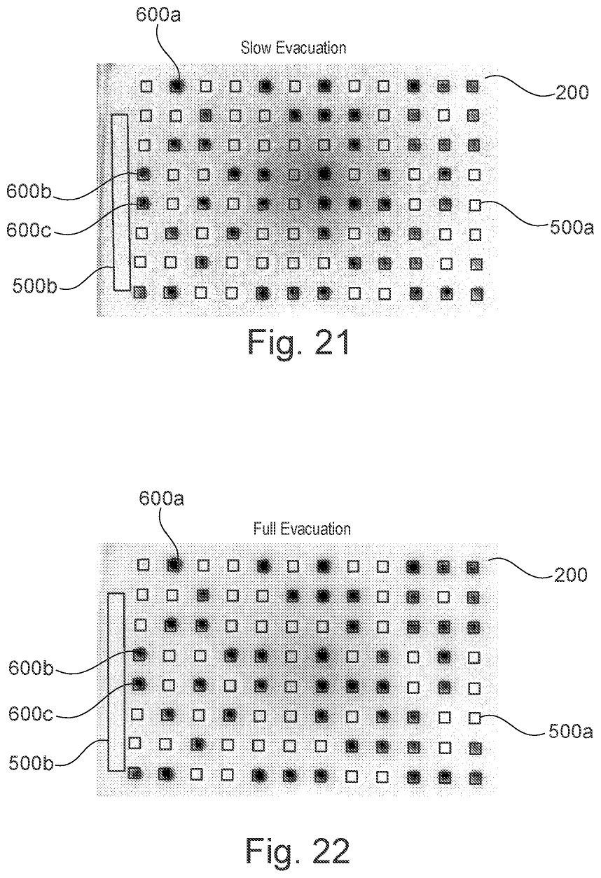

FIG. 21 shows the output from the thermal imaging camera during a slow evacuation of the vacuum chamber, while FIG. 22 show the output during a fast evacuation. It can be seen that the speed of the evacuation does not significantly affect the results for the samples under test.

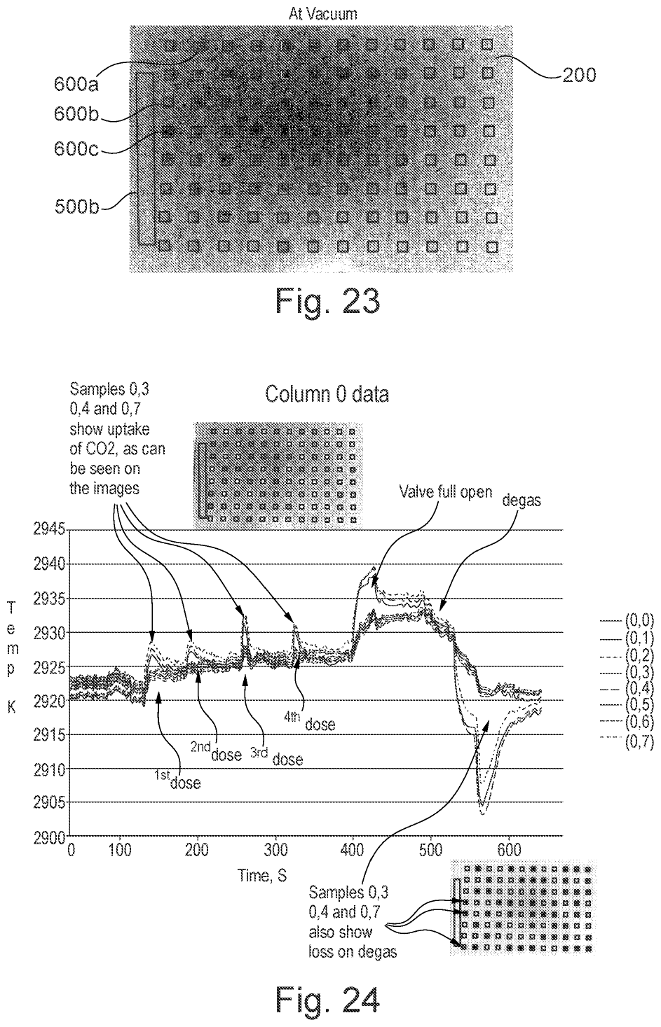

FIG. 23 shows the output from the thermal imaging camera when the vacuum chamber is at vacuum without any heating. It can be seen that the sample plate is uniformly cold.

Referring now to FIG. 24, there is shown a graph of sample temperature against time for the samples in the first column of the samples in the sample plate 200. The graph shows that for three samples, there is an increase in temperature for each quantity of carbon dioxide, and when the chamber is open to the gas canister. Furthermore, the graph further shows that for these three samples, their temperature drops during degassing.

By analysing the changes in temperature experienced by the sample materials in response to the admission of gas to the vacuum chamber, it is possible to determine how porous that material is to the test gas. The greater the temperature change the greater the gas sorption. Materials having a temperature change greater than a certain threshold may be considered to have good gas sorption properties.

By capturing multiple thermal images during a testing sequence, of one or more quantities of test gas, it is possible to generate plots like those shown in FIG. 24. Such plots may then be analysed to determine more detailed information, for example, the width and height of the peak each provide information on how the sample performs. Furthermore, a plot of pressure values (from the pressure transducer) against gas uptake may also provide useful information in relation to the behaviour of the material and the pores in the material.

Performing repeated tests allows the behaviour of the sample materials at low partial pressures can to be analysed. In particular, using repeated smaller test quantities of gas with an equilibration period in-between may show gas selectivity at lower pressures.

Integration of the area of each adsorption peak allows for a low resolution isotherm (LRI) to be constructed. The number of doses during the measurement dictates the number of isotherm points. The LRIs that can be prepared based on the data gathered by the system and method described herein can predict the shape of full isotherms generated from data from traditional sorption analysis such as volumetric or gravimetric analysis. This LRI is a compound product of the surface area of the test material, the interaction of the gas with the material (the isosteric heat), and to some degree the optical properties and colour of the material. In general, high surface area materials are easily distinguished from non-porous solids, notwithstanding any differences in colour, isosteric heat, and specific heat capacity.

It is also possible to compare the difference in isotherm shape of different materials for the same gas, for example micro-, meso- and macro-porous materials which give different shape isotherms.

The uptake of gas is proportional to the isosteric heat of adsorption (Qst) for that particular gas. To relate the temperature change and the quantity of gas adsorbed, ΔT and Qst may be compared; an increase in Qst corresponding with an increase in the magnitude of ΔT. This may allow for Qst to be predicted for unknown gases based upon the temperature change from the initial dose.

According to some examples, the amount of gas adsorbed is not quantified from the temperature data. However, by using the relationship between ΔT and Qst it is possible to identify which gas will bind strongest to the host and hence estimate gas selectivity.

According to some examples, normalised heat profiles may be compared for the initial dose of each gas, and differences in peak shape and width analysed. The peak width at half maximum (PWHM) may be measured, and may show a correlation between the diffusion coefficient and PWHM. Thus, a larger PWHM may indicate a slower diffusion of gases and hence slower kinetics. This may be used in ranking or estimating the kinetics of adsorption of a particular set of gases.

As described herein, one or more of the data from the thermal imaging camera, pixel information, temperature information, thermal images, etc. may be analysed to determine one or more of an indication of porosity, an indication of surface area, a low resolution isotherm, gas selectivity, an indication of uptake of gas, an indication of isosteric heat, estimated kinematic of adsorption, etc. In some examples, the analysis may be carried out by an analysis module or analysis circuitry. In some examples, the analysis module or analysis circuity form part of the control module 106. In other examples, the analysis module or analysis circuity is partially or entirely external to the control module 106. The analysis module or analysis circuity may include a processor, computing device, or the like, and may include a storage medium storing instructions that, when executed, cause the processor or computing device to carry out the analysis.

The following materials have been analysed in the gas sorption screening device and method described herein.

Porous Organic Cages:
CC1 alpha, CC2 alpha, CC3-rac, CC3a ground, CC3a large crystals, CC3 beta, CC3 amorphous, CC4 alpha, CC5, CC13 beta, RCC3, AT-RCC3, FT-RCC3

Conjugated Microporous Polymers:
CP-CMP1, CP-CMP2, CP-CMP3, CP-CMP4, CP-CMP5, CP-CMP6, CP-CMP7

Functionalised CMPs:
CMP-AMD-NH2, CMP-AMD-1, CMP-AMD-2, CMP-AMD-3, CMP-AMD-4, CMP-AMD-5, CMP-AMD-9

Microporous copolymers:
100 Aniline, 90 Ani/Ben, 80 Ani/Ben, 70 Ani/Ben, 60 Ani/Ben, 50 Ani/Ben, 40 Ani/Ben, 30 Ani/Ben, 20 Ani/Ben, 10 Ani/Ben, 100 Benzene

Other Porous polymers:
Knitted benzene, CMP-0, CMP-1, PIM-1, PAF-1

Activated Carbons
AC-1,AC-2, AC-3, AC-4, AC-5, AC-6, AC-standard

Zeolites, ZIFs and MOFs:
ZIF-8 (Strem), Uio-66 MOF (Strem), 13-X Zeo, Y-Zeo, BASF300, HKUST-1

Commercial polymers, standards and non-porous samples:
Mesoporous silica MCM-41(Micromeritics standard), mesoporous silica SBA-15 (Micromeritics standard), SiAl meso standard, salt, sand, macro-porous polystyrene, PVC, PMMA, PVP, PEI, NYLON6/6, PVA, Polystyrene, Al powder

The device and method described herein may be described as providing optical adsorption calorimetry. The thermal imaging camera measures the temperature change of each sample of material, which change is due to the release of heat of adsorption, as the material adsorbs a gas. Likewise there is a measurable decrease in temperature of the material as the gas is desorbed and this can also be used as an indication of porosity. The magnitude of temperature change depends on various factors including the heat capacity of the material, the heat released of adsorbed molecules and heat transfer properties.

This system and method described herein are capable of obtaining basic gas sorption data for a large number of samples, typically 96 or more, in a very short space of time, approximately 30 minutes. The system and method can give a definitive answer as to whether a material is porous or not to a particular gas. Other information can also be obtained, for example like for like samples can be compared to see which has the greatest adsorption capacity, shown by the largest temperature change. It is also possible to obtain approximate isotherm shapes and estimate the gas selectivity of a material. The system and method allow high-throughput screening of porosity of materials to a wide range of gases and will increase the likelihood of discovering new materials for associated applications.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for gas sorption screening of one or more test samples, the method comprising the steps of:
for each of one or more test materials, loading a sample area of a sample plate having a plurality of sample areas with a sample of the test material;
placing the loaded sample plate into a vacuum chamber having a IR-transparent window through which the top of the sample plate is visible;
outgas sing the one or more samples by establishing a vacuum in the vacuum chamber and heating the vacuum chamber;
admitting a test gas into the chamber;
detecting a change in temperature due to heat of adsorption by imaging the sample plate with a thermal imaging camera through the IR-transparent window.

2. A method as claimed in claim 1, further comprising deriving an indication of porosity based on the detected change in temperature.

3. A method as claimed in claim 1, further comprising estimating a gas selectivity based on the detected change in temperature.

4. A method as claimed in claim 1, wherein the detecting the change in temperature is carried out at room temperature or at around 20° C.

5. (canceled)

6. A method as claimed in claim 1, wherein the outgassing includes increasing the temperature to 80° C. or 300° C.

7.-9. (canceled)

10. A method as claimed in claim 1, wherein the step of admitting the test gas comprises admitting gas from a gas canister to a test gas delivery module, which test gas delivery module is in controlled fluid communication with the gas inlet of the vacuum chamber and after admitting the gas to the test gas delivery module, closing the test gas delivery module to the gas canister and opening the test gas delivery module to the gas inlet.

11. A method as claimed in claim 1, comprising the further steps of
allowing the vacuum chamber to reach an equilibrium temperature after admitting the test gas, and
admitting a further quantity of the test gas.

12. (canceled)

13. A method as claimed in claim 1, comprising repeatedly imaging the sample plate with the thermal imaging camera window after the sample plate has been placed into the vacuum chamber.

14.-15. (canceled)

16. A method as claimed in claim 13, comprising imaging the sample plate every second.

17.-19. (canceled)

20. A method as claimed in claim 1, comprising repeating the steps using a different test gas.

21. A method as claimed in claim 1, wherein the loading step comprises loading a well of a sample area with a sample of the test material.

22. A gas sorption screening device comprising:
a vacuum chamber adapted to receive a sample plate comprising a plurality of sample areas, and adapted to be temperature controlled, the vacuum chamber comprising a gas outlet adapted to be connected to a vacuum pump, a gas inlet adapted to be connected to a source of a test gas, and further comprising an IR transparent window;
a thermal imaging camera adapted to detect a change in temperature due to heat of adsorption by imaging the top of the sample plate through the IR-transparent window; and
a control module adapted to communicate with the thermal imaging camera.

23.-25. (canceled)

26. A device as claimed in claim 22, having the sample plate located therein.

27.-31. (canceled)

32. A device as claimed in claim 26 wherein some of the sample areas of the sample plate comprise a sample of a test material to be screened and some sample areas are empty.

33. A device as claimed in claim 22, further comprising a temperature control unit for controlling the temperature of the vacuum chamber, wherein the temperature control unit is adapted to control the temperature of the vacuum chamber in the range of approximately 20° C. to approximately 120° C.

34. (canceled)

35. A device as claimed in claim 22, further comprising a vacuum pump connected to the gas outlet of the vacuum chamber.

36. (canceled)

37. A device as claimed in claim 35, wherein the vacuum pump is adapted to implement a pressure of 1.2 Pa in the vacuum chamber.

38. A device as claimed in claim 22, further comprising a pressure transducer for sensing the pressure in the vacuum chamber, wherein the pressure transducer is adapted to communicate with the control module.

39. (canceled)

40. A device as claimed in claim 22, further comprising a test gas delivery module comprising a connector for fluid connection to a gas canister, the connector being in controlled fluid communication with a delivery container which is in turn in controlled fluid communication with the gas inlet of the vacuum chamber.

41. A device as claimed in claim 40, wherein the delivery container has a volume between 300 cm³ and 400 cm³.

42.-44. (canceled)
